(19) United States
(12) Patent Application Publication
(10) Pub. No.: US 2006/0048401 A1
(43) Pub. Date: Mar. 9, 2006

(54) Inclination measurement instrument

(76) Inventor: Takehiko Kishikawa, Saga (JP)

Correspondence Address: WENDEROTH, LIND & PONACK, L.L.P., 2033 K STREET N. W., SUITE 800, WASHINGTON, DC, 20006-1021, US

(21) Appl. No.: 10/532,798

(22) PCT Filed: Oct. 17, 2003
(86) PCT No.: PCT/JP03/13286

§ 371 Date: Apr. 25, 2005

(30) Foreign Application Priority Data
Nov. 12, 2002 (JP) 2002-328432
Jun. 13, 2003 (JP) 2003-169449

(51) Int. Cl. G01C 9/00

(52) U.S. Cl. 33/375

(57) ABSTRACT

An inclination measurement instrument formed by removing a pendulum and a circular dial from an inclinometer main body, which is less likely to cause a measurement error and capable of measuring an inclination of an object to be measured in a short time. The inclination measurement instrument has a main body frame (1) that is to be arranged along a face (H) to be measured, a reference arm (2) and a telescoping arm (3) that are brought into contact with the face (H) to be measured. The reference arm (2) and the telescoping arm (3) are formed at both ends of the main boy frame (1) so as to be perpendicular to the main body frame and oriented in the same direction. The telescoping arm (3) has a slide scale movable by telescoping the telescoping arm (3) and a bubble gauge for determining a level of the telescoping arm. The telescoping arm (3) is telescoped with the tip ends of the reference arm (2) and the telescoping arm (3) in contact with the face (H) to be measured, and the level of the telescoping arm (3) is adjusted based on the bubble gauge of the telescoping arm, and then the inclination of the face (H) to be measured can be measured by the slide scale.

### TECHNICAL FIELD

This invention relates to an inclination measurement instrument for measuring an inclination of pillars, floors, work pieces, or the like.

### BACKGROUND ART

In a method of measuring a degree of inclination of pillars or floors of buildings, or the like, a level vial or a plumb bob is used in general. With a level vial, a degree of inclination is confirmed by an air bubble. A plumb bob determines a degree of inclination by a value measured with a scale. Currently, as inclinometers for measuring an inclination value per 1 meter, known are a plumb bob inclinometer (trade name: Vertical Inclinometer V2) described in “Vertical Inclinometer V2”, [online], Kabushiki Kaisha Asia Consultant, [searched on Oct. 15, 2002], Internet <URL: http://www.asia-ct.com/research/kei.htm>(referred to as “Non-Patent Document No. 1” hereinafter) and a circular dial inclinometer (trade name: Dial Plumb Bob VH) described in “Dial Plumb Bob VH”, [online], Ozaki Mfg. Co., Ltd., [searched on Oct. 15, 2002], Internet <URL: http://www.peacockozakijp/sub01_{—}89.htm>(referred to as Non-Patent Document No. 2 hereinafter).

The plumb bob inclinometer described in Non-Patent Document No. 1 measures an inclination of a face to be measured with respect to the vertical direction by bringing a main body into contact with the face to be measured and determining the position of a pendulum hung from an upper part of the main body with a dial mounted on a lower part of the main body. The circular dial inclinometer described in Non-Patent Document No. 2 measures an inclination by bringing a main body into contact with a face to be measured and reading a circular dial that indicates an inclination of a pendulum housed in the main body.

In the above-described plumb bob inclinometer, a horizontal inclination can be measured with a bubble gauge provided on the main body. However, when measuring a vertical inclination, the pendulum has to be prepared as described above, which makes it difficult to measure a horizontal inclination and a vertical inclination alternately. Furthermore, when moving the inclinometer, the pendulum could hit against something damaging it or the pendulum itself.

In addition, if a leveling line by which the pendulum is hung touches the dial to generate friction between them, the inclination value is apt to be erroneously measured. Moreover, when measuring an inclination outdoors, the pendulum tends to be affected by wind, which lends to taking more time for measurement and other problems.

On the other hand, in the case of the circular dial inclinometer, the dial and a pointer must always be adjusted prior to measurement. Another problem is that the pointer trembles due to its sensitive reaction to vibration, which tends to cause a measurement error.

In view of the above problems, an object of the present invention is to provide an inclination measurement instrument formed by removing a pendulum and a circular dial from an inclination measurement instrument main body, which is less likely to have a measurement error and capable of measuring an inclination of an object to be measured in a short time.

### DISCLOSURE OF THE INVENTION

An inclination measurement instrument according to the present invention comprises a main body frame that is to be arranged along a face to be measured, a reference arm and a telescoping arm that are brought into contact with the face to be measured, wherein the reference arm and the telescoping arm are formed at both ends of the main body frame so as to be perpendicular to the main body frame and oriented in the same direction, and the telescoping arm has a slide scale movable by telescoping the telescoping arm and a bubble gauge for determining a level of the telescoping arm.

In the inclination measurement instrument of the present invention, the reference arm and the telescoping arm formed at both ends of the main body frame so as to be perpendicular to the main body frame and oriented in the same direction are brought into contact with the face to be measured, and the telescoping arm is telescoped so that the level of the telescoping arm is adjusted based on the bubble gauge of the telescoping arm. When the telescoping arm becomes level, the main body frame is arranged along the face to be measured in a vertical direction. The degree of telescoping of the telescoping arm or the indication of the slide scale at this point shows the inclination of the face to be measured with respect to the vertical direction.

Here, preferably, the bubble gauge can be observed from both upper and under sides of the telescoping arm. By this structure, whichever the reference arm or the telescoping arm is positioned on a top side when measuring an inclination, a level of an object to be measured can be confirmed with the bubble gauge mounted on a top face of the telescoping arm in any case. The number of the bubble gauge can be one or more.

Preferably, the telescoping arm can be provided with a driving mechanism that drives a telescoping operation of the telescoping arm. The driving mechanism can be constructed so as to convert a rotary movement of a rotating member into a telescoping movement of the telescoping arm and transmit thereto. With this driving mechanism, the telescoping operation of the telescoping arm can be fine adjusted, thereby easily adjusting the level of the telescoping arm.

Preferably, the reference arm can be provided with a protrusion formed on a portion to be in contact with the face to be measured on an outer side of the main body frame. With the protrusion attached to a corner where the face to be measured such as a pillar or a wall meets a sill or a floor, a gap is formed between the reference arm and the sill, floor, or the like. Thus, the reference arm can be tilted supported by the protrusion as a fulcrum.

Preferably, the main body frame can be provided with a bubble gauge for determining a level of the main body frame. With this structure, when the reference arm and the telescoping arm formed at both ends of the main body frame so as to be perpendicular to the frame and oriented in the same direction are brought into contact with the face to be measured, and the bubble gauge indicates the level by telescoping the telescoping arm, the main body frame can be confirmed to be level. The degree of telescoping of the telescoping arm or the indication of the slide scale at this point shows the inclination of the face to be measured with respect to the horizontal direction.

The present invention can exhibit the following effects.

(1) The instrument comprises a main body frame that is to be arranged along a face to be measured in a vertical direction, a reference arm and a telescoping arm that are brought into contact with the face to be measured, wherein the reference arm and the telescoping arm are formed at both ends of the main body frame so as to be perpendicular to the main body frame and oriented in the same direction, and the telescoping arm has a slide scale movable by telescoping the telescoping arm and a bubble gauge for determining a level of the telescoping arm. Therefore, the inclination of an object to be measured in a vertical direction can be easily measured in a short time. As the instrument is not provided with a pendulum and a circular dial, a measurement error can also be prevented.

(2) The bubble gauge can be observed from both upper and under sides of the telescoping arm. Accordingly, whichever the reference arm or the telescoping arm is positioned on a top side when measuring an inclination, a level of an object to be measured can be confirmed with the bubble gauge mounted on a top face of the telescoping arm in any case. Thus, when an object to be measured is at a high position, the level of the object can be measured with the reference arm positioned on a top side and the telescoping arm on a bottom side, and the bubble gauge mounted on a top face of the telescoping arm can be observed from a position above the telescoping arm to exactly determine the level of the telescoping arm, which can also realize an easy inclination measurement for a tall fence, wall, or the like.

(3) As the instrument is structured without a pendulum and a circular dial, there are no necessity to adjust the circular dial or a pointer and thus no error in adjustment. This makes it possible for anyone to easily measure a vertical inclination. Moreover, since a measurement operation can be continued without waiting for a pendulum and a pointer to stop moving, a vertical inclination can be quickly measured in a short time. Furthermore, the instrument without a leveling line can be easily carried, and also there is no chance of an interruption of the operation due to a break of the leveling line that occurs with a conventional instrument.

(4) Since a degree of an inclination is indicated by the sliding scale with high precision, the instrument is applicable to any of construction of general buildings, building examination, and damage examination in public works that requires highly precise measured values. Conventionally, there have been measurement instruments that confirm only a degree of vertical and horizontal inclination with a bubble gauge but no inclination measurement instruments that can determine a measurable quantity before the instrument of the present embodiment.

(5) The reference arm is provided with a protrusion formed on a portion to be in contact with a face to be measured on an outer side of the main body frame. The protrusion is attached to an intersection point of the face to be measured such as a pillar and a corner of a sill or the like, and the reference arm is tilted supported by the corner to which the protrusion is attached as a fulcrum, thereby making the measurement easy. When the telescoping arm is telescoped, the position of the protrusion remains unchanged to serve as a fulcrum to easily measure an inclination as well.

(6) The main body frame provided with a bubble gauge for determining a level of the main body frame makes it possible to immediately measure a horizontal inclination following to the easy measurement of a vertical inclination as described above. Accordingly, vertical/horizontal inclinations can be measured alternately.

### BRIEF DESCRIPTION OF THE DRAWINGS

FIGS. 1A and 1B are drawings illustrating an inclination measurement instrument according to an embodiment of the present invention as a whole, wherein FIG. 1A is a front view and FIG. 1B is a right side view;

FIGS. 2A and 2B are drawings illustrating a telescoping arm in FIGS. 1A and 1B in detail, wherein FIG. 2A is a plan view of FIG. 1A and FIG. 2B is a sectional view taken along the line A-A in FIG. 2A;

FIGS. 3A to 3C are detailed drawings illustrating another embodiment of the telescoping arm, wherein FIG. 3A is a plan view corresponding to FIG. 2A, FIG. 3B is a sectional view taken along the line B-B in FIG. 3A, and FIG. 3C is a bottom plan view of FIG. 3A;

FIGS. 4A and 4B are detailed drawings illustrating yet another embodiment of the telescoping arm, wherein FIG. 4A is a plan view corresponding to FIG. 2A and FIG. 4B is a sectional view taken along the line C-C in FIG. 4A;

FIG. 5 is a plan view illustrating yet another embodiment of the telescoping arm, which corresponds to FIG. 2A;

FIGS. 6A and 6B are drawings illustrating examples of measuring vertical inclinations, wherein FIG. 6A is a side view illustrating an example of measuring a face to be measured such as a pillar or a wall which stands on a plane surface and FIG. 6B is a side view illustrating an example of measuring a face to be measured such as a block wall which stands on ground;

FIG. 7 is an explanatory view illustrating relationships between inclinations of a pillar and length of a telescoping arm;

FIGS. 8A to 8C are explanatory drawings illustrating relationships between inclinations of a pillar and length of a telescoping arm; and

FIG. 9 is a side view illustrating an example of measuring a horizontal inclination.

### BEST MODE FOR CARRYING OUT THE INVENTION

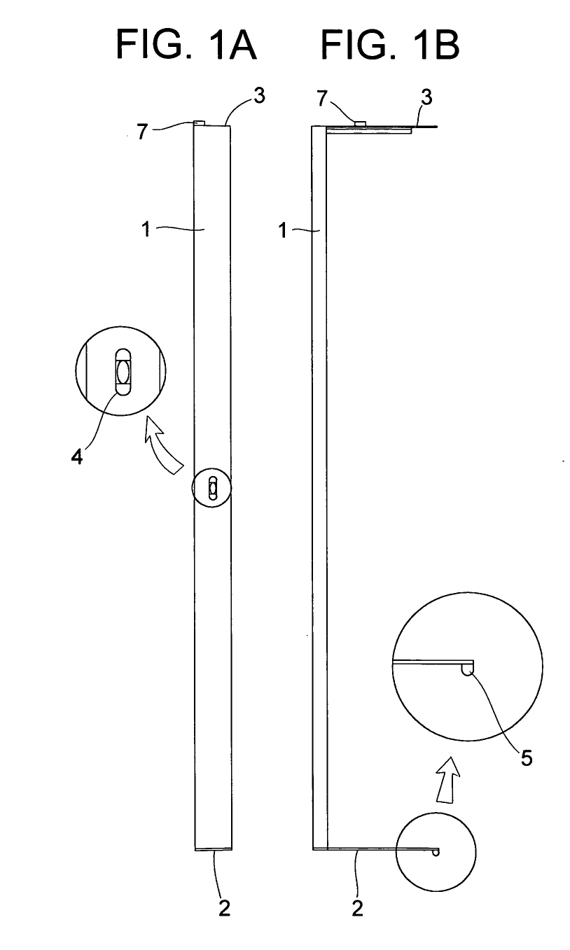

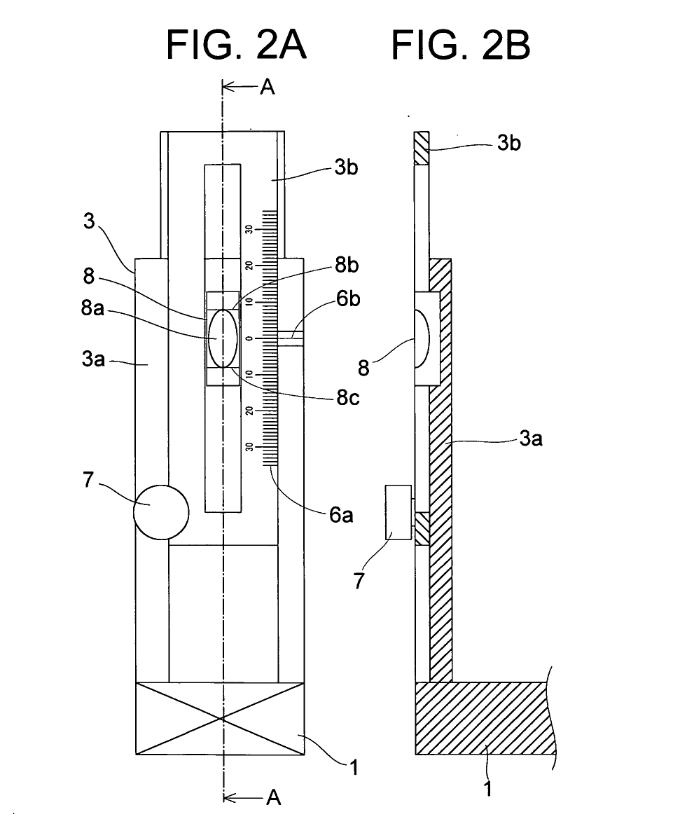

FIGS. 1A and 1B are drawings illustrating an inclination measurement instrument according to an embodiment of the present invention as a whole, wherein FIG. 1A is a front view and FIG. 1B is a right side view. FIGS. 2A and 2B are drawings illustrating a telescoping arm in FIGS. 1A and 1B in detail, wherein FIG. 2A is a plan view of FIG. 1A and FIG. 2B is a sectional view taken along the line A-A in FIG. 2A.

In FIGS. 1A and 1B, an inclination measurement instrument in the present embodiment comprises a pillar-shaped main body frame 1 having a length of 1000 mm with a reference arm 2 and a telescoping arm 3 that are formed at both ends of the main body frame 1 so as to be perpendicular to the main body frame 1 and oriented in the same direction. The main body frame 1 is provided with a bubble gauge 4 for determining a level of the main body frame 1 at a center thereof. The reference arm 2 has a predetermined length, and a protrusion 5 having a round surface extending toward an outside of the main body frame 1 is formed at a tip end thereof.

As shown in FIGS. 2A and 2B, the telescoping arm 3 has a slider frame 3a which is fixed to the main body frame 1 and a slider 3b which slides inside the slider frame 3a. On an upper face of the slider 3b, graduations 6a are provided for indicating degrees of inclination of a face to be measured. On the other hand, on the slider frame 3a, a reference line 6b is provided at a position serving as a zero reference for the graduations 6a of the slider 3b.

The telescoping arm 3 as described above telescopes as the slider 3b slides inside the slider frame 3a. In other words, the slider frame 3a and the slider 3b constitute a slide scale, in which a length of the telescoping arm 3 from the main body frame 1 is to be identical with a length of the reference arm 2 from the main body frame 1 when the zero reference of the graduations 6a of the slider 3b corresponds to the reference line 6b.

Though it is not illustrated in the drawings, the telescoping arm 3 has a driving mechanism consisting of a rack and a pinion to drive the slider 3b. The driving mechanism transmits a rotary movement of a dial 7 provided on the slider frame 3a as a rotating member to the rack via the pinion, thereby converting the movement into the sliding movement of the slider 3b or the telescoping movement of the telescoping arm 3.

The slider frame 3a also has a cylindrical bubble gauge 8 for determining a level of the telescoping arm 3 in a telescoping direction at a position corresponding to the reference line 6b at a center of the slider frame 3a. The bubble gauge 8 is mounted so as to be observed from an upper side of the slider 3b. On a cover of the bubble gauge 8, side lines 8b and 8c are provided tangent to both sides of an air bubble 8a with a center thereof at the position of the air bubble 8a when the telescoping arm 3 is level. The air bubble 8a moves in the telescoping direction of the telescoping arm 3. When the air bubble 8a stays between the side lines 8b and 8c, the telescoping arm 3 is level in the telescoping direction. Here, any superfluous lines other than the side lines 8b and 8c are not provided on the cover of the bubble gauge 8.

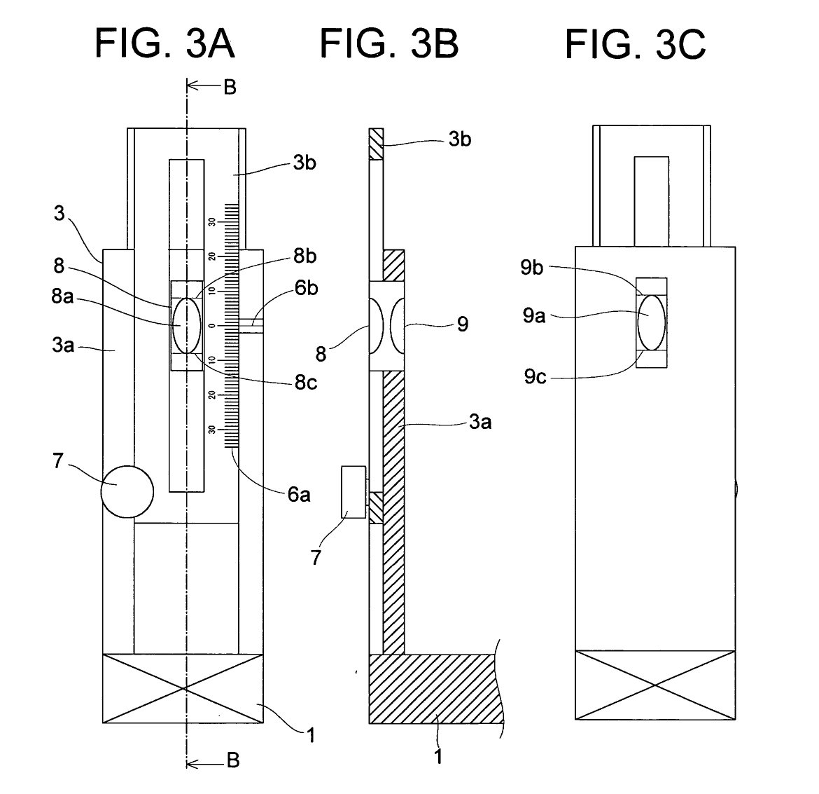

As shown in FIGS. 3A to 3C, an inclination measurement instrument of the present embodiment may be further provided with a bubble gauge 9 that can be observed from an under side of the slider 3b. The bubble gauge 9 has an air bubble 9a as well as side lines 9b and 9c as in the bubble gauge 8. Thus, provided with the bubble gauges 8 and 9 on both upper and under sides of the telescoping arm 3, whichever the reference arm 2 or the telescoping arm 3 is positioned on a top side when measuring an inclination, the level can be determined with either of the bubble gauges 8 or 9 that is mounted on a top face of the telescoping arm 3 in any case.

As shown in FIGS. 3A to 3C, the bubble gauges can be mounted on both upper and under sides of the telescoping arm 3, whereas only one bubble gauge (not shown) can be mounted to be exposed to both upper and under sides of the telescoping arm 3 so that the one bubble gauge can be observed from both top and bottom faces of the telescoping arm 3.

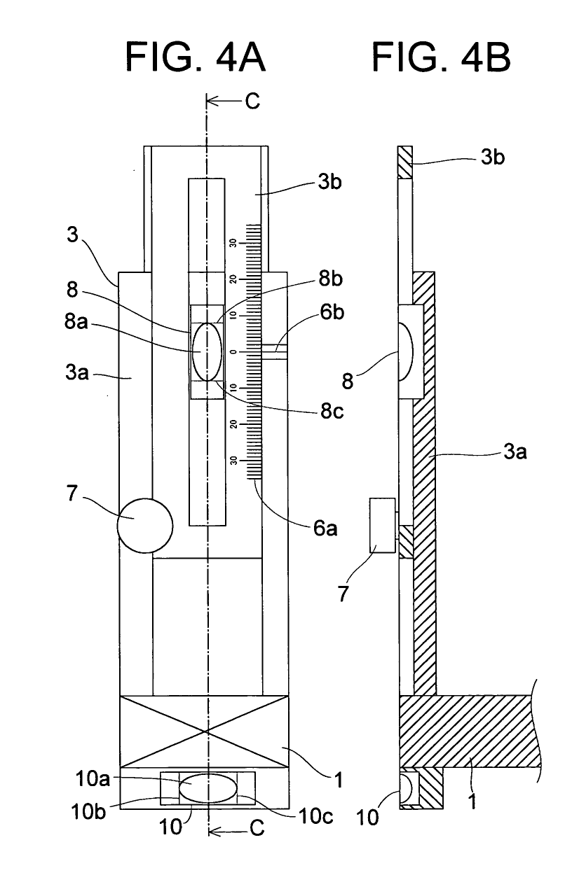

As shown in FIGS. 4A and 4B, an inclination measurement instrument of the present embodiment may be further provided with a bubble gauge 10 for determining a level of the telescoping arm 3 in a direction perpendicular to the telescoping direction. In an example shown in FIGS. 4A and 4B, the bubble gauge 10 is mounted on an end portion of the main body frame 1 on a side of the telescoping arm 3. The bubble gauge 10 also has an air bubble 10a and side lines 10b and 10c as in the bubble gauge 8.

The air bubble 10a moves in a direction perpendicular to the telescoping direction of the telescoping arm 3. When the air bubble 10a stays between the side lines 10b and 10c, the telescoping arm 3 is level in a direction perpendicular to the telescoping direction. Specifically, the main body frame 1 can be easily positioned in a vertical direction by confirming the level of the telescoping arm 3 in the direction perpendicular to the telescoping direction with the bubble gauge 10.

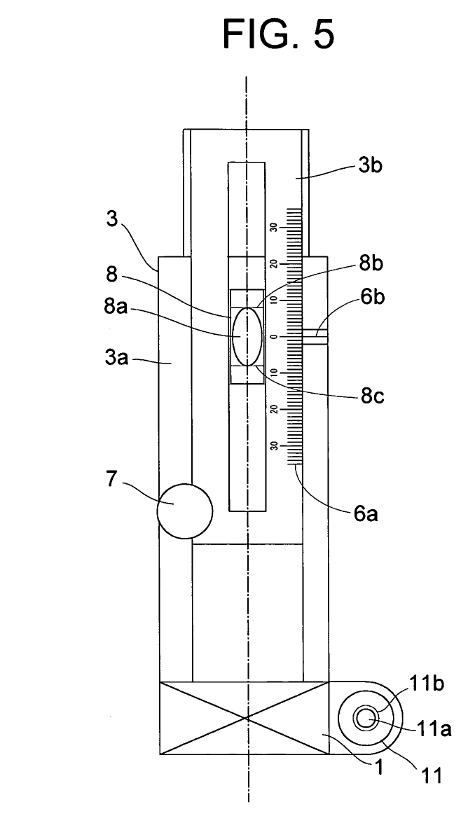

Alternatively, as shown in FIG. 5, an inclination measurement instrument of the present embodiment may be further provided with a round-shaped bubble gauge 11 capable of determining both a telescoping direction and a direction perpendicular to the telescoping direction of the telescoping arm 3. In an example shown in FIG. 5, the bubble gauge 11 is mounted on an end portion of the main body frame 1 on a side of the telescoping arm 3. The bubble gauge 11 has an air bubble 11a, and a circular side line 11b is provided on a hemispheric cover of the bubble gauge 11 so as to surround the air bubble 11a when the telescoping arm 3 is level.

As in the bubble gauge 9 described above, a plurality of the bubble gauges 10 or 11 can be mounted on both upper and under sides of the telescoping arm 3, or one of the bubble gauge 10 or 11 can be mounted to be exposed to both upper and under sides of the telescoping arm 3 so as to be observed from both upper and under sides of the telescoping arm 3. By this structure, even when the reference arm 2 and the telescoping arm 3 are positioned upside down, the vertical state of the main body frame 1 can be confirmed with the bubble gauge 10 or 11.

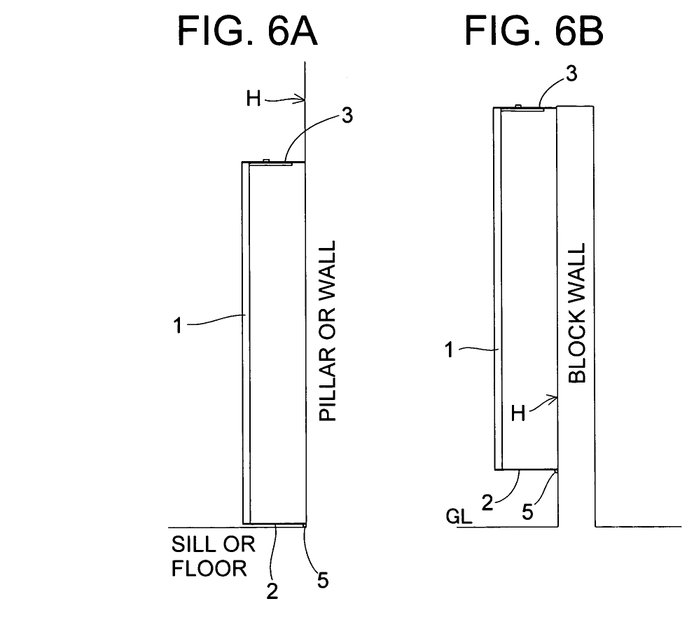

A method of measuring inclinations using the inclination measurement instrument having the above-described structure will be explained below referring to FIG. 6A to FIG. 9. FIGS. 6A and 6B are drawings illustrating examples of measuring vertical inclinations.

As shown in FIG. 6A, when an inclination of a face H to be measured such as a pillar, a wall, and the like (referred to as “pillar” hereinafter) standing on a horizontal plane such as a sill, a floor, and the like (referred to as “sill” hereinafter) is measured with respect to a vertical direction, the protrusion 5 of the reference arm 2 of the inclination measurement instrument of the present embodiment is attached to an intersection point of the sill and the pillar. In this state, a tip end of the reference arm 2 is brought into contact with the face H to be measured of the pillar.

Then, a tip end of the telescoping arm 3 formed on the other side of the main body frame 1 of the inclination measurement instrument of the present embodiment is brought into contact with an upper portion of the face H to be measured of the pillar, and the dial 7 is rotated to adjust a length of the telescoping arm 3 so that the air bubble 8a of the bubble gauge 8 is positioned between the side lines 8b and 8c.

When the air bubble 8a of the bubble gauge 8 is positioned between the side lines 8b and 8c, that is, when the telescoping arm 3 becomes level with the tip ends of both the reference arm 2 and the telescoping arm 3 in contact with the face H to be measured, the main body frame 1, with the reference arm 2 and the telescoping arm 3 formed on both ends thereof to be perpendicular thereto, is positioned in a vertical direction along the face to be measured.

At this point, the indication of the graduations 6a of the slider 3b which corresponds to the reference line 6b of the slider frame 3a shows a degree of inclination of the face H to be measured. Here, as the graduations 6a of the slider 3b are disposed on a top side of the inclination measurement instrument, no change of posture is necessary to read the graduations 6a, and also a position of the air bubble 8a can be easily confirmed by the side lines 8b and 8c on the cover.

In the inclination measurement instrument having the bubble gauges 8 and 9 which can be observed from both upper and under sides of the telescoping arm 3 as described above, when an object to be measured is at a high position, an upside-down position of the state shown in FIGS. 6A and 6B can be employed when measuring an inclination. Specifically, the reference arm 2 can be positioned on a top side with the telescoping arm 3 on a bottom side. In this case, the bubble gauge 9 which is mounted on a top face of the telescoping arm 3 on the bottom side can be confirmed from above the telescoping arm 3 to precisely determine a level of the telescoping arm 3. Thus, also an inclination of a tall fence, wall, or the like can be easily measured.

If the inclination measurement instrument of the present embodiment is provided with the bubble gauges 10, 11, it can be easily confirmed with the bubble gauges 10, 11 whether the main body frame 1 is vertical or not as described above. Accordingly, the inclination measurement instrument can be free from fluctuation in measured values due to measurement errors or repeated measurement operations, or errors caused by biased ways of measurement acquired by each measurer or the like.

The inclination measurement instrument can be structured to have either only one or both of the bubble gauges 10 and 11. Also, the bubble gauges 10, 11 can be fixed to the inclination measurement instrument in advance or can be structured to be attachable to the inclination measurement instrument.

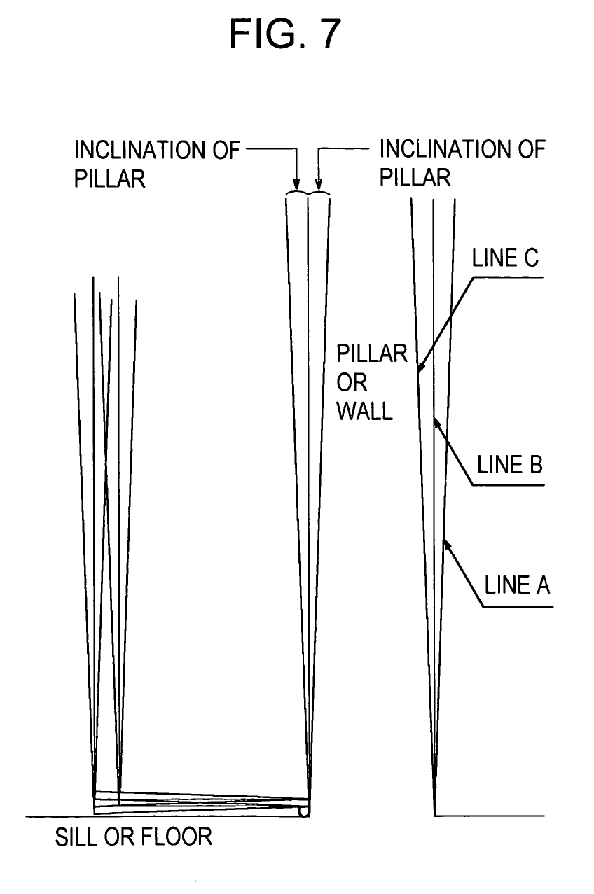

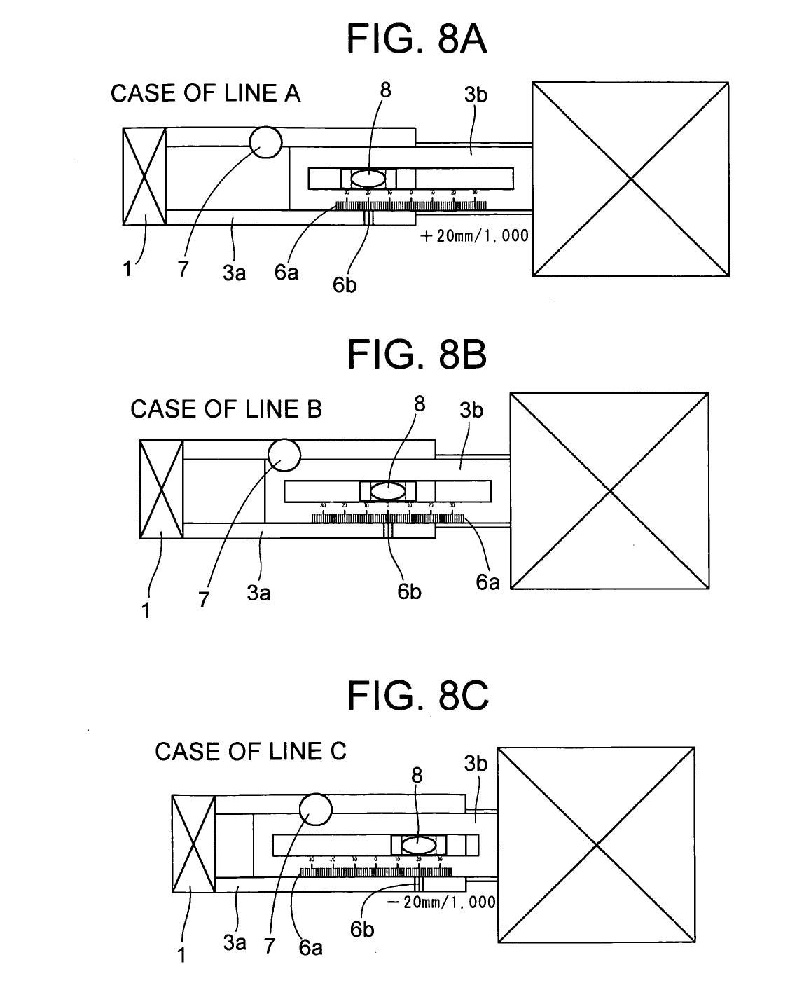

FIG. 7 and FIGS. 8A to 8C illustrate relationships between inclinations of a pillar and length of the telescoping arm 3. A line B in FIG. 7 shows a state in which the pillar stands with an angle of 90 degrees (perpendicular/vertical) with respect to a sill. Lines A and C show states in which the pillar is inclined with an obtuse angle and an acute angle, respectively.

As shown in FIG. 8B, when the pillar stands with an angle of 90 degrees (the state shown by the line B in FIG. 7), the reference line 6b of the slider frame 3a corresponds to the zero reference of the graduations 6a of the slider 3b. At this point, a length of the reference arm 2 from the main body frame 1 is identical with a length of the telescoping arm 3 from the main body frame 1, and the main body frame 1 is positioned in a vertical direction along the face H to be measured and in parallel to the face H to be measured. In other words, it is recognized that the face H to be measured is positioned with an angle of 90 degrees with respect to the sill.

On the other hand, as shown in FIG. 8A, when the inclination of the pillar with respect to the sill is greater than 90 degrees (the state shown by the line A in FIG. 7), the reference line 6b of the slider frame 3a corresponds to a positive value of the graduations 6a of the slider 3b (an extending direction of the telescoping arm 3). In the illustrated example, the reference line 6b corresponds to the position of +20 mm, which means that the telescoping arm 3 is 20 mm longer than the reference arm 2. In this case, the main body frame 1, which is positioned in a vertical direction along the face H to be measured, is inclined by +20 mm/1000 mm with respect to the face H to be measured. Namely, it is recognized that the face H to be measured is inclined by +20 mm/1000 mm with respect to the sill.

As shown in FIG. 8C, when the inclination of the pillar with respect to the sill is smaller than 90 degrees (the state shown by the line C in FIG. 7), the reference line 6b of the slider frame 3a corresponds to a negative value of the graduations 6a of the slider 3b (a contracting direction of the telescoping arm 3). In the illustrated example, the reference line 6b corresponds to the position of −20 mm, which means that the telescoping arm 3 is 20 mm shorter than the reference arm 2. In this case, the main body frame 1, which is positioned in a vertical direction along the face H to be measured, is inclined by −20 mm/1000 mm with respect to the face H to be measured. Namely, it is recognized that the face H to be measured is inclined by −20 mm/1000 mm with respect to the sill.

In the example shown in FIG. 6A, the protrusion 5 of the reference arm 2 of the inclination measurement instrument of the present embodiment is attached to an intersection point between the sill and the pillar. As shown in FIG. 6B, however, when measuring a vertical inclination of the face H to be measured standing on ground such as a block wall, for example, a tip end of the reference arm 2 may be brought into contact with the face H to be measured instead of attaching the protrusion 5 to an intersection point between the block wall and the ground.

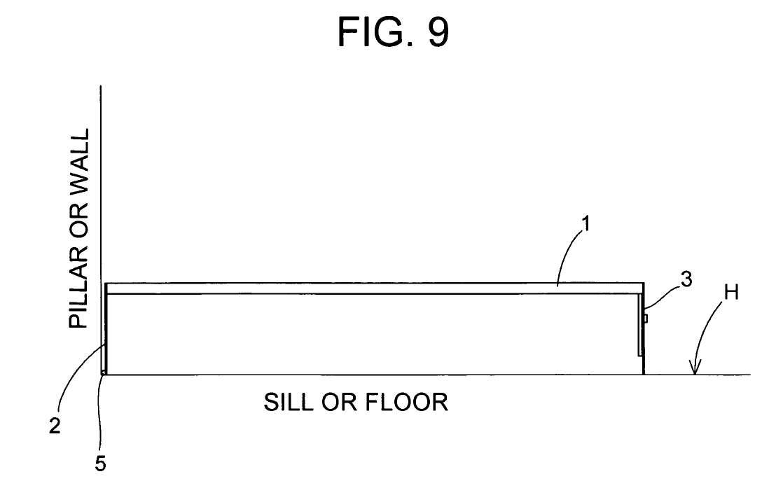

The inclination measurement instrument of the present embodiment can be used for measuring a horizontal inclination as shown in FIG. 9. FIG. 9 illustrates an example of measuring a horizontal inclination with respect to the face H to be measured such as a sill and a floor. In this case, the reference arm 2 and the telescoping arm 3 are brought into contact with the face H to be measured, and the telescoping arm 3 is telescoped so that the bubble gauge 4 shows leveling. Thus, the main body frame 1 can be confirmed to be leveled. At this point, the indication of the graduations 6a of the slider 3b which corresponds to the reference line 6b of the slider frame 3a shows a degree of inclination of the face H to be measured in a horizontal direction. Also, when the zero reference of the graduations 6a of the slider 3b corresponds to the reference line 6b, that is, when a length of the telescoping arm 3 is identical with a length of the reference arm 2, if the bubble gauge 4 shows leveling, the face to be measured can be confirmed to be leveled. In the case that there is a pillar, a wall, or the like that stands from the face H to be measured, the inclination is measured by attaching the protrusion 5 to an intersection point of the face H to be measured and the pillar, wall, or the like.

As described above, in the inclination measurement instrument of the present embodiment, while a conventional pendulum and circular dial have been removed from an inclination measurement instrument main body, the telescoping arm 3 is telescoped with the reference arm 2 and the telescoping arm 3 of the main body frame 1 in contact with the face H to be measured, and the level thereof is adjusted with reference to the bubble gauge 8 so that a vertical inclination of the face H to be measured can be easily measured in a short time. In addition, when the orientation of the main body frame 1 is changed with an angle of 90 degrees from the states in FIGS. 6A and 6B to the state in FIG. 9 in use, a horizontal inclination can be immediately measured, which facilitates vertical/horizontal inclinations to be measured alternately.

Furthermore, the absence of a conventional pendulum and circular dial eliminates measurement errors caused by the reasons such as a swing of a pendulum by wind in outdoor operations, friction between a leveling line and a circular dial, and trembling of a pointer. Also, there are no necessity to adjust a pendulum, a circular dial or a pointer and thus no error in adjustment. This makes it possible for anyone to easily measure a vertical inclination. The measurement operation can be easily carried out by simply rotating the dial 7. Moreover, since measurement operation can be continued without waiting for a pendulum and a pointer to stop moving, a vertical inclination can be quickly measured in a short time. In addition, the instrument without a leveling line can be easily carried, and also there is no chance of an interruption of the operation due to a break of the leveling line that occurs with a conventional instrument.

Since a measured value of an inclination can be indicated with high precision or in units of millimeters by the graduations 6a of the sliding scale 3b that constitutes the sliding scale, the instrument is applicable to any of construction of general buildings, building examination, and damage examination in public works that requires highly precise measured values. Conventionally, there have been measurement instruments that confirm only a degree of vertical and horizontal inclination with a bubble gauge but no inclination measurement instruments that can determine a measurable quantity before the instrument of the present embodiment.

The reference arm 2 is provided with the protrusion 5 on a portion to be in contact with the face H to be measured on an outer side of the main body frame 1. When measuring an inclination, the protrusion 5 can be used by attaching it to an intersection point of the face H to be measured such as a pillar and a corner of a sill or the like. In this state, as the reference arm 2 does not have any direct contact with the sill or the like, which forms a gap between the reference arm 2 and the sill or the like, the reference arm 2 can be tilted supported by the corner to which the protrusion 5 is attached as a fulcrum. Accordingly, when the telescoping arm is telescoped, the position of the protrusion 5 of the reference arm 2 remains unchanged to serve as a fulcrum, thereby making the measurement easy. The protrusion 5 of the present embodiment having a round surface, in particular, facilitates a swinging operation of the main frame body 1 supported by the corner to which the protrusion 5 is attached as a fulcrum when measuring an inclination, which realizes further easier measurement.

### INDUSTRIAL APPLICABILITY

An inclination measurement instrument according to the present invention is useful as a measurement instrument for determining an inclination of pillars, floors, work pieces, or the like.

1. An inclination measurement instrument comprising:
a main body frame that is to be arranged along a face to be measured, and
a reference arm and a telescoping arm that are brought into contact with the face to be measured, wherein
said reference arm and said telescoping arm are formed at both ends of the main body frame so as to be perpendicular to the main body frame and oriented in the same direction, and
said telescoping arm has a slide scale movable by telescoping the telescoping arm and a bubble gauge for determining a level of the telescoping arm.

2. The inclination measurement instrument according to claim 1, wherein said bubble gauge determines a level of the telescoping arm in a telescoping direction.

3. The inclination measurement instrument according to claim 1, wherein said bubble gauge determines a level of the telescoping arm in a direction perpendicular to a telescoping direction.

4. The inclination measurement instrument according to claim 2, wherein said bubble gauge determines a level of the telescoping arm in a direction perpendicular to a telescoping direction.

5. The inclination measurement instrument according to claim 1, wherein said bubble gauge can be observed from both upper and under sides of the telescoping arm.

6. The inclination measurement instrument according to claim 1, further comprising a driving mechanism that drives a telescoping operation of the telescoping arm.

7. The inclination measurement instrument according to claim 6, wherein said driving mechanism converts a rotary movement of a rotating member into a telescoping movement of the telescoping arm.

8. The inclination measurement instrument according to claim 1, wherein said reference arm is provided with a protrusion on a portion to be in contact with the face to be measured on an outer side of the main body frame.

9. The inclination measurement instrument according to claim 1, wherein said main body frame is provided with a bubble gauge for determining a level of the main body frame.
